(19) United States
(12) Patent Application Publication
(10) Pub. No.: US 2009/0091425 A1
(43) Pub. Date: Apr. 9, 2009

(54) Pager Solutions For Wireless Device System And Associated Methods

(76) Inventor: Richard Sharpe, Woodridge, IL (US)

Correspondence Address: LATHROP & GAGE LC, 4845 PEARL EAST CIRCLE, SUITE 300, BOULDER, CO, 80301, US

(21) Appl. No.: 12/335,441

(22) Filed: Dec. 15, 2008

Related U.S. Application Data
(63) Continuation-in-part of application No. 11/182,136, filed on Jul. 15, 2005.
(60) Provisional application No. 61/013,933, filed on Dec. 14, 2007.
(60) Provisional application No. 61/099,103, filed on Sep. 22, 2008.

(51) Int. Cl. G08B 5/22; G06F 3/041

(52) U.S. Cl. 340/7.21; 340/7.63; 340/7.39; 345/173

(57) ABSTRACT

2-way pagers, methods and software products implement two-way paging between a first wireless device and a second wireless device. A key sequence is accepted at the first wireless device to compose information of a page. The page is sent from the first wireless device to the second wireless device, the page comprising information of a network ID, a pager ID, a pagee ID and a page code. The page is received at the second wireless device and the second wireless device is validated as being configured for the network ID of the page. A confirmation is sent from the second wireless device to the first wireless device to confirm that the page was received.

### RELATED APPLICATIONS

This application is a continuation-in-part of U.S. patent application Ser. No. 11/182,136, filed Jul. 15, 2005, which is incorporated herein by reference. This application also claims priority to U.S. Provisional Application No. 61/013,933, filed Dec. 14, 2007, and U.S. Provisional Application No. 61/099,103, filed Sep. 22, 2008, each of which is incorporated herein by reference.

### BACKGROUND

Paging systems are used in a variety of applications such as TV and radio transmission, cellular/PCS communications and pager services. In association with wide area networks, existing pager repeaters typically only provide one-way communication. By way of example, a base station antenna typically transmits a signal to a pager, sometimes utilizing tower-mounted repeaters. The signal may contain a return phone number for reaching the person who is calling the pager.

Paging systems that cover broad geographic areas typically employ sophisticated networks of repeaters mounted on transmission towers. Tower-mounted repeater systems are often used to extend the range of a base station and to fill nulls in the coverage area of the base station. These paging systems generally include: a link antenna that is directed/aimed at a base station antenna; repeater electronics, and a broadcast antenna that is directed towards the area of interest. Often, the link antenna is highly directional, with high gain and a very narrow beam because it only needs to “see” the base station antenna. The broadcast antenna has a wider beam, to cover the intended area. Thus, traditional pager repeaters only provide for one-way communication with the pager and do not transmit signals to the base station antenna.

One recent advance provides pagers that allow two way communications; i.e., the pager also transmits signals. Thus, additional full base station antennas are required to provide two-way pager coverage over large areas. This is because full base stations are required to send and receive pager signals over large areas, as compared to the capability of highly directional link antennas. However, full base station antennas are costly to construct and expensive to maintain.

Typical paging systems require a user to enter full information of a text message, resulting in user interfaces wherein a user may be faced with options such as using more than one key to enter a letter (e.g., keys of a telephone keypad) or must use a keyboard that has a key for each letter (e.g., a “qwerty” keyboard), which may form an inconveniently large keyboard or inconveniently small keys.

### SUMMARY OF THE INVENTION

A pager that is capable of two-way communications (a “2-way pager”) overcomes the problems outlined above and advances the art by operating on a local network of 2-way pagers. The instructions direct the wireless device to operate in infrastructures mode.

In one embodiment, a 2-way pager, includes a transceiver for transmitting a sent page and for receiving a received page, a user interface for displaying information of the received page and for inputting information of the sent page, memory configured to store a list of pagee IDs, a list of page codes and an emergency page list, the emergency page list defining one or more pagees, an emergency page function for sending, using the transceiver, an emergency page to each pagee defined within the emergency page list, and a processor responsive to the user interface and the memory for associating a selected pagee ID with a selected page code to compose the sent page, and for invoking the emergency page function.

In another embodiment, a method duplicates configuration of a pager. One or more second pagers are set into a clone receive mode and a first pager to be cloned is set into a clone transmit mode. The first pager performs the steps of: transmitting an ID of the first pager; transmitting contact information from stored data of the first pager; transmitting pager code information from the stored data. Each of the second pagers has a second pager ID and performs the steps of: receiving the first pager's ID; receiving the contact information; updating the contact information by replacing the second pager's ID with the first pager's ID; storing the updated contact information within a memory of the second pager; receiving the pager code information; storing the pager code information within the memory of the second pager; transitioning the first pager back to a normal operation mode; and transitioning the second pager back to a normal operation mode.

In another embodiment, a software product has instructions, stored on computer-readable media, wherein the instructions, when executed by a processor, perform steps for two-way paging between a first wireless device and a second wireless device, including: instructions for accepting, at the first wireless device, input from a user of the first wireless device, the input composing information of a first page on the first wireless device, the input specifying the second wireless device as the recipient of the first page, the first page comprising information of a pager ID of the first wireless device, a pagee ID of the second wireless device, and a page code; instructions for transmitting the first page from the first wireless device to the second wireless device; instructions for receiving, at the second wireless device, the first page; instructions for ignoring, at the second wireless device, the first page if the pagee ID is not equal to a pager ID of the second wireless device; instructions for displaying the first page on a display of the second wireless device if the pagee ID is equal to a pager ID of the second wireless device; and instructions for sending, from the second wireless device, a page confirmation message to the first wireless device to confirm that the first page was received.

### BRIEF DESCRIPTION OF THE FIGURES

FIG. 1 shows a block schematic diagram of one 2-way pager.

FIG. 2A shows a front view of one 2-way pager.

FIG. 2B shows a back view of one 2-way pager.

FIG. 3 illustrates a local network, showing how 2-way pagers may communicate with each other.

FIG. 4 is a flowchart of one exemplary process of 2-way paging.

FIG. 5 is a flowchart of a learn mode of a 2-way pager.

FIG. 6 is a flowchart of a repeater mode of a 2-way pager.

FIG. 7 is a flowchart of a send page mode of a 2-way pager.

FIG. 8 is a flowchart of a receive page mode of a 2-way pager.

FIG. 9 shows a side view of one 2-way pager mounted in a belt-clip.

FIG. 10 shows an embodiment of a 2-way pager, similar to the 2-way pager of FIG. 1

FIG. 11 shows one exemplary process for transmitting cloning information from the 2-way pager of FIG. 10.

FIG. 12 shows one exemplary process for receiving cloning information within the 2-way pager of FIG. 10.

FIG. 13 shows an embodiment of a 2-way pager, implemented using a wireless device.

FIG. 14 shows a front view of an exemplary embodiment of a 2-way pager software application running on an Apple™ iPhone™ wireless device.

FIG. 15 illustrates a local network, showing how wireless devices configured as 2-way pagers may communicate with each other.

FIGS. 16A and 16B show a side view of a wireless device configured as a 2-way pager and mounted in a belt-clip.

FIG. 17-FIG. 20 show front views of an exemplary embodiment of an Apple™ iPhone™ wireless device in several different modes of operation.

### DETAILED DESCRIPTION OF THE FIGURES

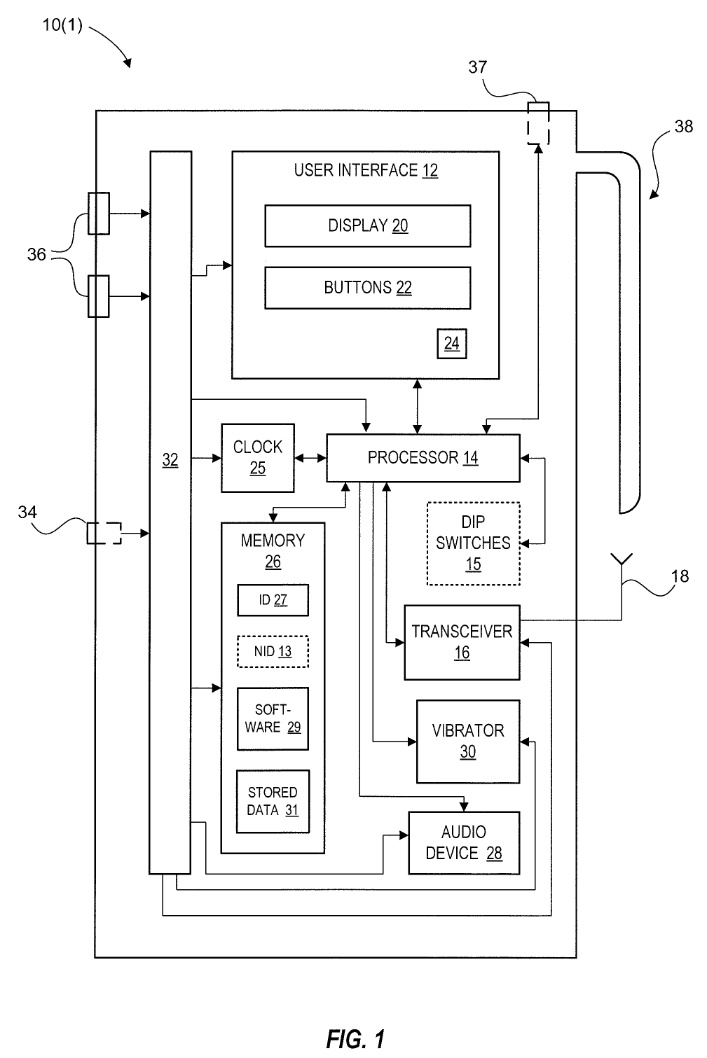

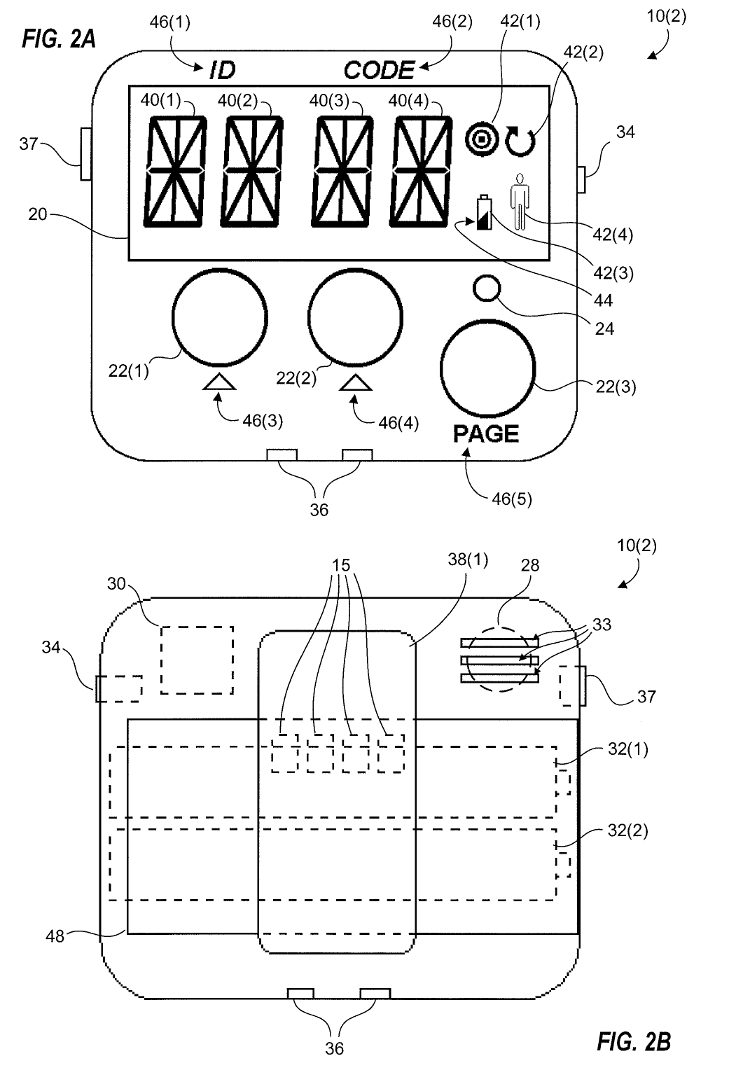

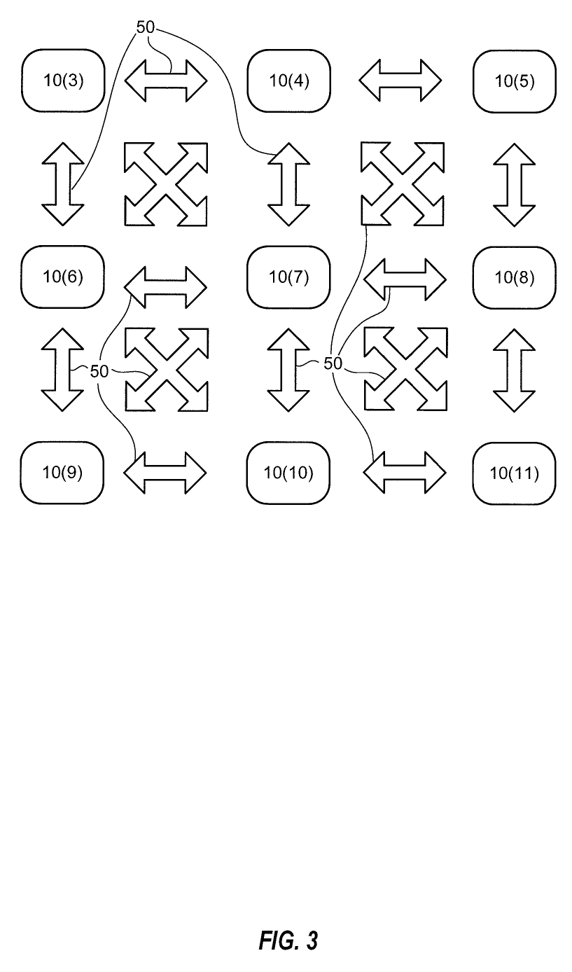

FIG. 1 shows a block schematic diagram of one 2-way pager 10(1). Pager 10(1) has a user interface 12 that responds to user input for managing, displaying and/or sending information. For example, user interface 12 has buttons 22 that a user may press to set up and/or send a page to another pager, or that the user may press to display and/or acknowledge a received page. User interface 12 also includes a display 20 that can display numeric, alphanumeric and/or graphical symbols to the user (see FIG. 3). An optional indicator 24 (e.g., page received confirmation indicator 24, FIG. 2) may, for example, indicate when a page sent from pager 10(1) is acknowledged. In an alternate embodiment, indicator 24 may be incorporated into display 12.

A processor 14 executes software 29 that may be stored in a memory 26 to control implementation of the functions described herein by pager 10(1); it is appreciated that processor 14 and memory 26 may be discrete components or may reside within a single component. Memory 26 may be, for example, nonvolatile memory. Pager 10(1) optionally includes a clock 25 (e.g., a real time clock chip) in communication with processor 14; clock 25 provides time and/or date information that may be displayed on display 20 and/or included in information of pages (e.g., sent and/or received pages) by processor 14. It is appreciated that memory 26 and/or clock 25 may be separate components from processor 14, or they may be integrated (e.g., in a single microchip). In addition to holding software 29, memory 26 may also hold an identification code (“ID”) 27 that is assigned to pager 10(1), and stored data 31 that may include, for example, lists of pages received, IDs of pagees (persons paged) within a network of pager 10(1), and codes representing page code used within the network, as described in more detail below.

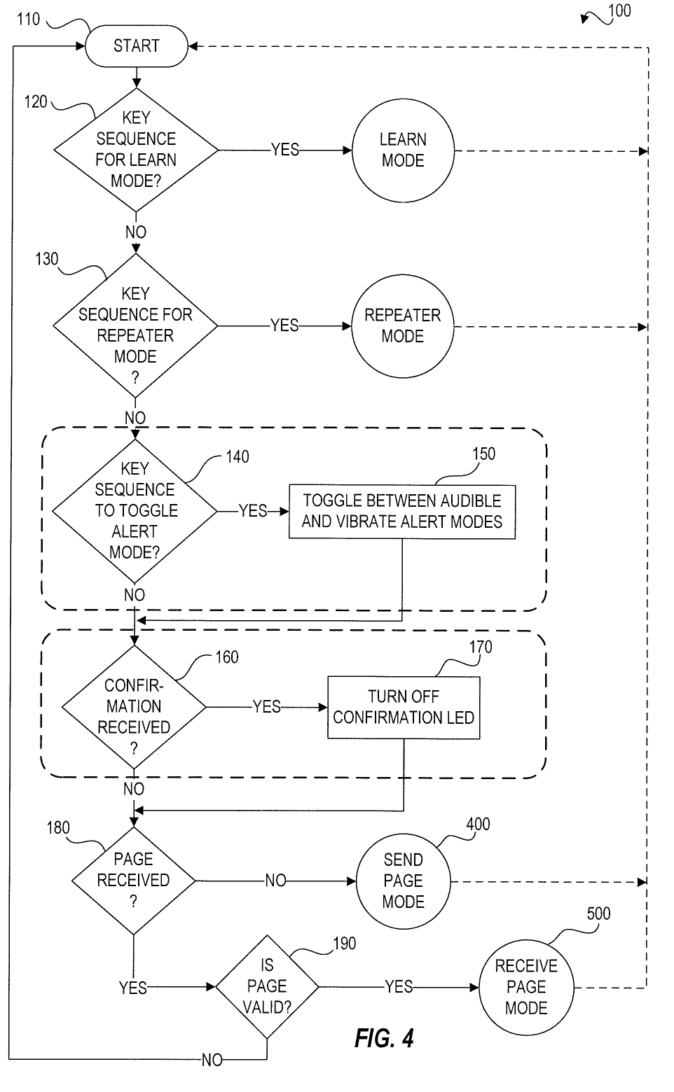

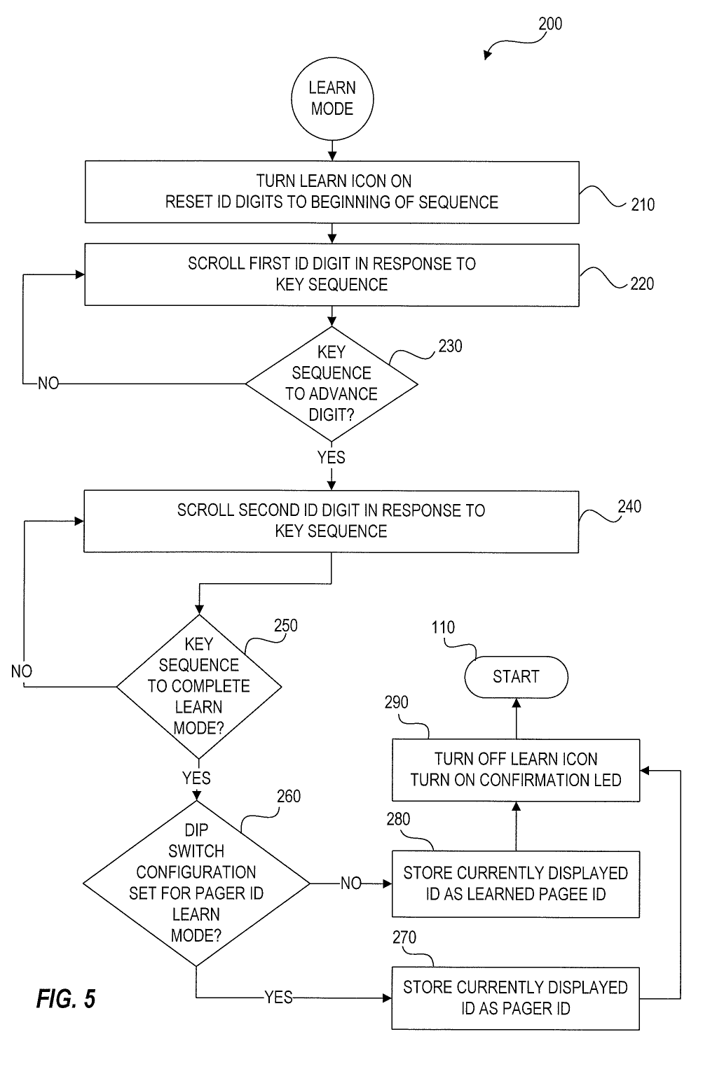

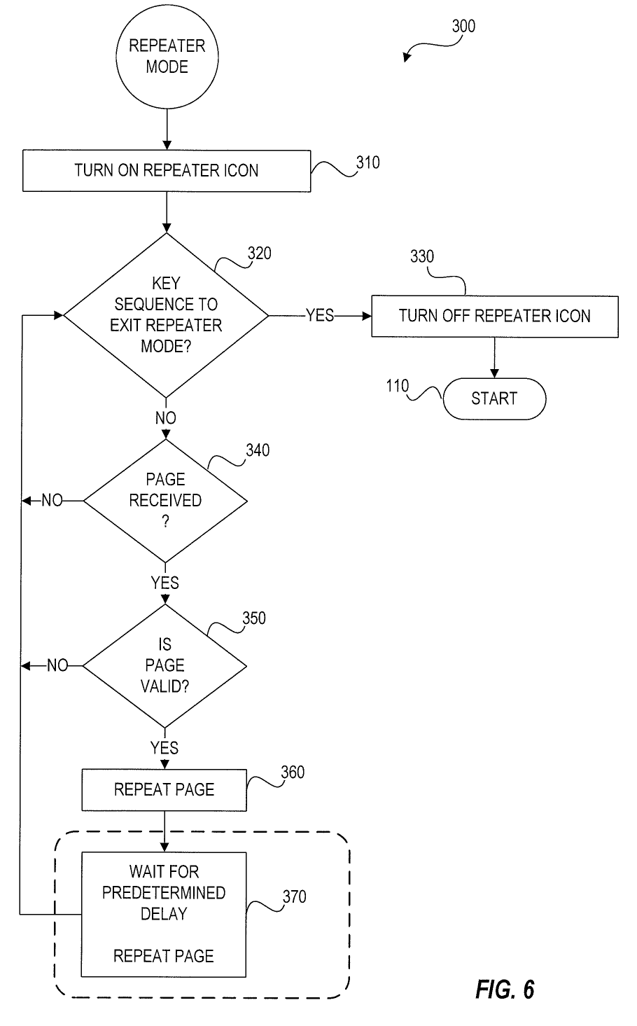

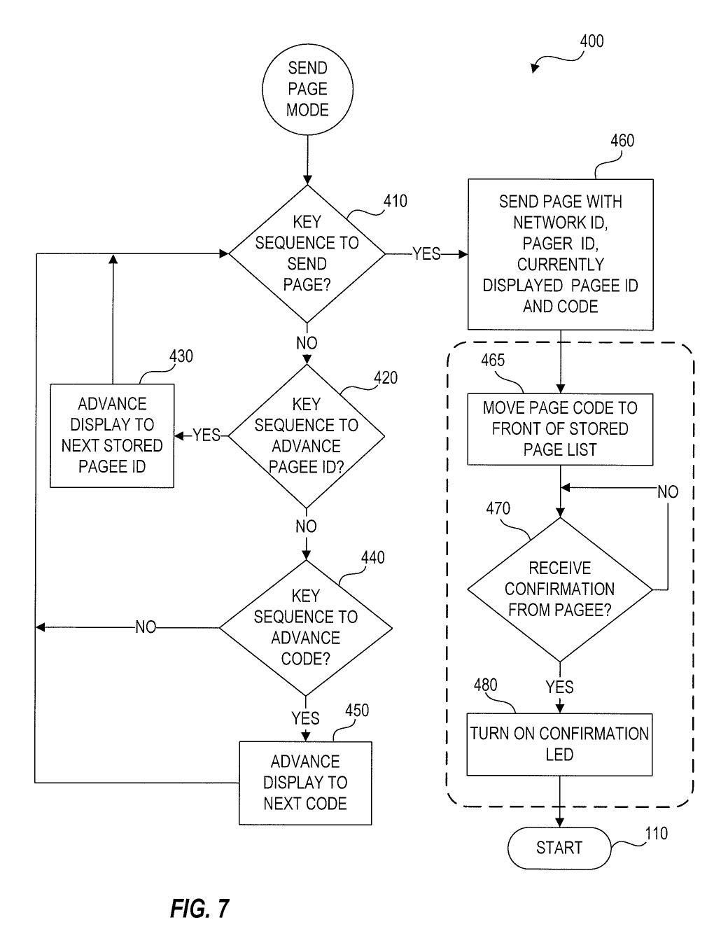

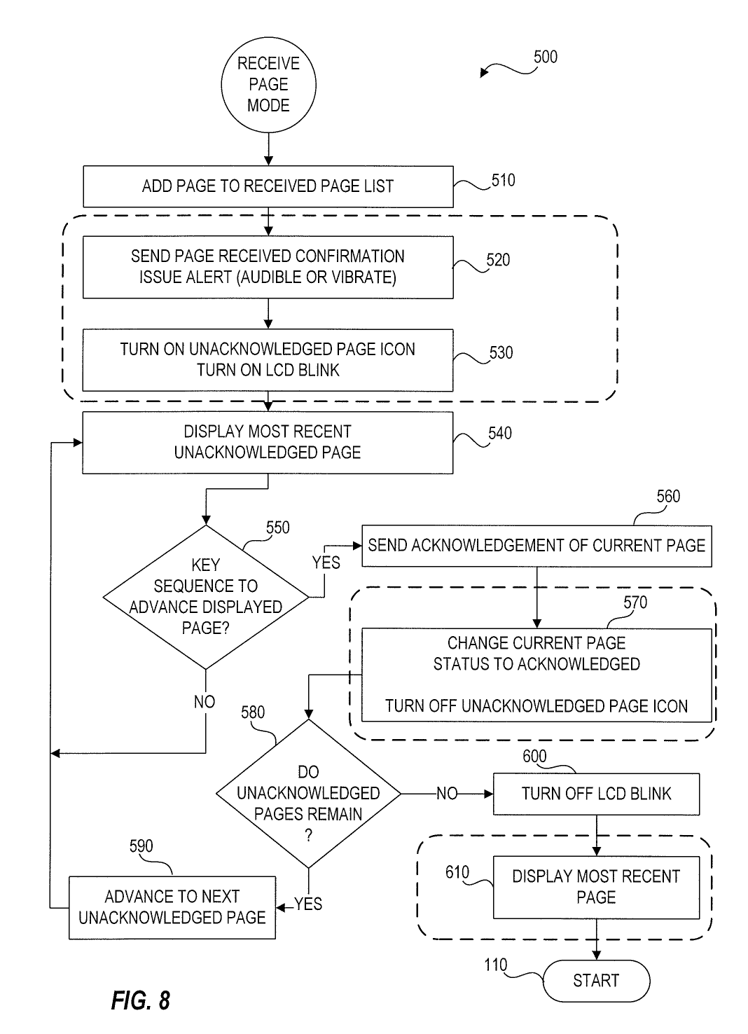

A transceiver 16 transmits data from pager 10(1) and receives data to pager 10(1), via an antenna 18. Display 20, controlled by processor 14, displays data (see, e.g., FIG. 2 and FIG. 4) to the user. For example, display 20 may indicate (1) information of one or more received pages (see FIG. 8); (2) information of a page being composed for sending (see FIG. 7); (3) an indication that pager 10(1) is operating in repeater mode (see FIG. 6); (4) information of an ID being composed while pager 10(1) is in learn mode (see FIG. 5); (5) an indication that a page is pending (e.g., as in “page indicator” of FIG. 2); and/or (6) current time and/or date information. Display 20 may operate in a static mode, such that information displayed on display 20 does not change unless forced by an event (such as receipt of a page or a user operating buttons of pager 10(1)), or it may operate in a dynamic mode, with display 20 or parts thereof flashing to indicate significance of some piece of information (such as a received page or a low battery condition), or it may sequence through multiple screens of information (such as alternating between page information and date/time information.) Display 20 may be, for example, an LCD or LED display.

Pager 10(1) optionally includes DIP switches 15 that communicate with processor 14. DIP switches 15 may be used, for example, to provide network information to processor 14 so that processor 14 can encode the network information into transmitted pages, and only other 2-way pages with the same network information will receive the pages, so that multiple networks of pagers can operate in one area without interfering with each other. Alternatively, the network information (e.g., network ID 13, shown as “NID 13”) may be encoded into memory 26.

A power source 32 may power pager 10(1); power source 32 may include, for example, one or more AAA batteries. Pager 10(1) optionally includes an input power socket 34 and/or battery contacts 36 for recharging power source 32 and/or for operating pager 10(1) from an external power source. Pager 10(1) optionally includes an audio output device 28 and/or a vibrator 30 that can generate one or more signals to alert the user to an incoming page. Pager 10(1) optionally includes a computer interface port 37 for rapid setup of ID 27 and stored data 31 in memory 26. Pager 10(1) optionally includes a positioning element 38 that may be, for example, a belt clip, a key ring or a stand.

In one embodiment, a 2-way pager 10 (as exemplified by pager 10(1), FIG. 1 and pager 10(2), FIG. 2) operates in a localized area where certain individual pagers 10 act as repeaters to cover a desired range that is larger than the localized area. The use of pagers 10 as repeaters may for example provide cost savings, particularly if their range is only about 200 feet. The use of one or more 2-way pagers as repeaters thus creates a network that does not require sophisticated towers and antennas to span large distances.

In one embodiment, a 2-way pager 10 conveys the ID of the person(s) sending the page, the ID of the pager 10 belonging to the person(s) being paged (hereinafter known as the pagee) and an additional short code, rather than sending numeric, text or voice messages (although numeric, text and voice messages may also be conveyed by pager 10). In one example, a page is created by selecting the ID of the pagee's pager 10 (“pagee ID”) and a code (“page code”) that may follow a convention adopted by the pager and the pagee; the sent page also includes the ID of the pager 10 that sends the page (“pager ID”). For example, pager IDs and pagee IDs may be a user's initials or other cipher representing a user of pager 10, and page code may be a location where the pagee is expected to go, an activity the pagee is expected to perform or a situation the pagee is to be alerted to. The use of page codes thus supplants other, more complicated methods of communicating such as keying in a phone number or a text message, although in some embodiments phone numbers and text messages may also be sent by a 2-way pager 10. Furthermore, the pagee may be selected from a list of pagee IDs stored in memory 26; the ability to select both pagee ID and page code from a limited number of available codes provides fast and efficient paging. In one embodiment, a 2-way pager 10 may initially store a list of all possible codes in an initial order. When a page containing a given code is sent, the list is rearranged by taking the code that was in the sent page out of the initial order and placing it at the front of the list. Over time, as certain codes are paged more often than others, the list is reordered to a list that tends to have the most frequently paged codes at the front of the list, and the least frequently paged codes at the end of the list. When a page is composed for sending on a 2-way pager 10, a portion of display 20 shows the pagee ID and page code to be sent; when the page is received by another 2-way pager 10, the corresponding portion of display 20 shows the pager ID and the page code. As described in more detail below, a 2-way pager 10 may include one or more of the following features:

Each 2-way pager 10 has an ID to identify a user and/or a group of users. The ID of
a 2-way pager 10 sending a page is called the pager ID, while the ID of a 2-way
pager 10 that receives the page is called the pagee ID.
Each page may contain information such as a network ID, a pager ID, a pagee ID,
and/or a page code signifying information to be communicated to the pagee. Each
page may optionally include time and/or date information.
A 2-way pager 10 that receives a page may display a pager ID (an ID of a 2-way
pager 10 that sent the page) and a page code entered by the user that sends the page.
A 2-way pager 10 that sends a page may display confirmation that the page was
received.
A 2-way pager 10 that sends a page may display confirmation that the 2-way pager
receiving the page has displayed the sent page.
A number of 2-way pagers 10 within one local network is limited only by number of
characters used for the ID 27 stored in memory 26 of each 2-way pager 10.
A number of characters used to store and display IDs and page codes may be from 2
to 10 characters.
2-way pager 10 may generate an audio tone (e.g., a beep), a vibration and/or visual
indications of events such as, for example, receipt of a page, confirmation of a sent
page being received and/or displayed.
2-way pager 10 may automatically send a page received confirmation message to the
sending 2-way pager 10 to indicate that the page was successfully received. The
confirmation message includes the same information as the page, and additional
information indicating that the message is a confirmation message (so that
confirmation messages are not erroneously interpreted as new pages).
Sending 2-way pager 10 may retransmit a page if a page receive confirmation is not
received within a designated time.
2-way pager 10 may sends a displayed acknowledgement message to the sending 2-
way pager when a page is displayed on display 20 for the first time.
A user may display a page by pressing a designated button on 2-way pager 10.
2-way pager 10 may store a list of received pages and may store status of each page
as acknowledged or unacknowledged.
2-way pager 10 may flash information such as the pager's ID and/or code on the
display when scrolling through received pages. Flashing may stop when a given
page is viewed, or when all received pages have been acknowledged.
2-way pager 10 has a small size.
2-way pager 10 may have a clip that stands the pager on a flat surface and/or loops
around a belt.
2-way pager 10 may have a range of 100-200 feet (without extended transmission
via a repeater).
DIP switch settings may allow assignment of a network code to 2-way pager 10,
allowing different local networks to be co-located; DIP switch settings may also
allow a 2-way pager 10 to differentiate learning its own ID from learning a pagee ID
in a learn mode.
2-way pager 10 may indicate the presence of one or more unacknowledged pages.
2-way pager 10 may be configured to operate as a repeater.
2-way pager 10 may have rechargeable battery contacts to allow rechargeable
batteries to be installed and charged.
2-way pager 10 may have a socket to allow it to be powered and/or to allow charging
of batteries from an external power supply.
2-way pager 10 may have a port for connection with external devices for rapid setup
(e.g., pager ID setup and importation of pagee ID and page code lists).
2-way pager 10 is operable for sending pages and configuration using a single hand.

To send a page, a user may select (a) a pagee ID from a list of pagee IDs to be paged and/or (b) a page code from a list of page codes that is stored within memory 26 of a 2-way pager 10. The use of stored lists of pagee IDs and page codes may make it unnecessary for a user to use a complicated user interface to key in phone numbers or other text information. The user may press, for example, a page button 22(3) (see FIG. 2A) to send the page. The sent page may specify the ID of the sending pager, the selected pagee ID, and the selected page code, and may also specify a network ID of the sending pager (as configured by DIP switches 15, FIG. 1 and FIG. 2 or defined within memory 26) and date/time information of the sending pager. The page code may indicate an office where the pagee is to meet the user, for example, or it may indicate an action to be performed by the pagee.

When a 2-way pager 10 receives a page, it first determines whether the page is already the last entry in a list of received pages that is stored (e.g., in memory 26). If the received page is already the last entry in the list of received pages it is ignored, otherwise it is added to the list of received pages, and the user is alerted (e.g., by output of audio device 28 or vibrator 30).

In an illustrative example of operation, a doctor's office may have ten employees, each with a 2-way pager 10 that allows paging from any employee to any other employee within a local 2-way network. Each 2-way pager 10 processes and stores received pages (e.g., as stored data 31 within memory 26 of each pager 10) for future addressing use, thereby eliminating the need to key in pagee IDs or page codes. A doctor may select the pagee ID of an employee he wants to meet at his office. The doctor need only press a few buttons 22 on pager 10 to select a pagee ID of the employee and a page code that corresponds to “go to the office,” and then to press the page button 22(3) (see FIG. 2A), to summon the employee to the office. The 2-way pager 10 of the employee receives the ID of the doctor that sent the page, and the page code that corresponds to “go to the office.” In this example, operation of each 2-way pager 10 is very simple since there is no need to enter an area code, a phone number or a text message. Since 2-way pager 10 is compact and may include three buttons 22, as shown in FIG. 2A, 2-way pager 10 facilitates single handed operation, thereby leaving the user's other hand available for other tasks. For example, 2-way pager 10(2) may be held in one hand and operated by a thumb of that hand.

FIG. 2A and FIG. 2B show front and back views, respectively, of a 2-way pager 10(2). Pager 10(2) may include some or all of the features of pager 10(1) (FIG. 1), with like numerals being used where applicable; specific examples of generic features are identified by numerals in parenthesis (e.g., buttons 22(1)-22(3) are specific examples of buttons 22).

In FIG. 2A, display 20 of pager 10(2) includes LCD numerals 40(1)-40(4) and LCD icons 42(1)-42(4). LCD numerals 40(1) and 40(2) may display an ID, and LCD numerals 40(3) and 40(4) may display a page code, as discussed above. When pager 10(2) receives a page, LCD icon 42(1) may indicate that the page has been received but not yet acknowledged. LCD icon 42(2) may indicate whether pager 10(2) is functioning as a repeater (see FIG. 4 and FIG. 6). LCD icon 42(3) may indicate a condition of power supply 32 (FIG. 1); a visually “filled” portion 44 may indicate, for example, a relative amount of charge in batteries 32(1) and 32(2) (described below). LCD icon 42(4) may indicate when pager 10(2) is in a “Learn” mode (see FIG. 4 and FIG. 5). All of LCD numerals 40(1)-40(4) and LCD icons 42(1)-42(4) may be controlled by a processor (e.g., processor 14, FIG. 1). Display 20 may be large enough, for example, that LCD numerals 40(1)-40(4) and LCD icons 42(1)-42(4) may be read at a distance, enabling a user to see contents of a page when pager 10(2) is at belt level without having to move pager 10(2). In an alternative embodiment, a display 20 may have more digits and/or icons than shown in display 20(1), for example, a display 20 may have certain digits that typically display ID and page code information, and other digits that display time and/or date information

Printed (or raised or embossed) indicia such as, for example, indicia 46(1)-46(5) may be present to help a user understand the meaning and function of features of pager 10(2); such indicia may also be customized for a given application. For example, indicia 46(2) that reads as “CODE” in FIG. 2A may read as “ROOM” for a pager 10 used in a doctor's office, as “TABLE” for a pager 10 used by a server or manager in a restaurant, or as “DISH” for a pager 10 used by a short order cook in a restaurant. Button 22(1) is an “ID advance” button; button 22(2) is a “Code advance” button; button 22(3) is a “Page” button; exemplary functions of these buttons are explained below in connection with FIG. 4 through FIG. 8. Input power socket 34, battery contacts 36 and computer interface port 37 are also shown.

In FIG. 2B, positioning element 38(1) is for example a belt clip, however other positioning elements such as a stand may be utilized. Two batteries 32(1) and 32(2) are shown in dashed outline as they are hidden, in this view, behind a battery cover 48. Also hidden behind battery cover 48, and partially beneath batteries 32(1)-32(2), are four DIP switches 15 that may be used to define a network that pager 10(2) belongs to, as discussed in connection with FIG. 1, and/or (2) to change the ID of a pager, as discussed below in connection with FIG. 5. Pager 10(2) forms holes 33 over audio device 28 that is otherwise hidden within pager 10(2). Vibrator 30 is also shown as hidden within pager 10(2). Input power socket 34, battery contacts 36 and computer interface port 37 are also shown.

Variations in number, position and type of elements shown in FIG. 2A and FIG. 2B are within the scope of the current disclosure. For example, although FIG. 2A shows two LCD numerals corresponding with ID digits and two LCD numerals corresponding with code digits, different numbers and types of numerals may be used, the ID and code digits may be different in numbers or be in separate displays, and separate displays may be of differing types. Different numbers of buttons may be used and may correspond with different functions than the exemplary functions described in connection with FIG. 4 through FIG. 8.

When pager transmission range is unimpeded by intervening objects, each 2-way pager 10 may have a range of about 200 feet. A 2-way pager 10 may also be configured to operate as a repeater, meaning that a pager so configured re-transmits any page that it receives, instead of acknowledging and displaying the page (see FIG. 4 and FIG. 6). A pager 10 configured as a repeater extends the range of the local network; when one or more 2-way pagers 10 at appropriate locations are repeaters, the range of the local network may be extended to allow 2-way pagers 10 to communicate beyond their individual communication range (i.e., beyond 200 feet, see FIG. 3). Repeaters may also be used to overcome pager communication coverage problems (caused for example by shapes of and/or materials used in certain buildings). A pager 10 configured as a repeater treats a confirmation message like any other incoming page; that is, it repeats the confirmation message so as to relay it back to the sending 2-way pager 10.

FIG. 3 illustrates an exemplary embodiment of a local network, showing how 2-way pagers 10(3)-10(11) may communicate with each other. Each of pagers 10(3)-10(11) has a range indicated by arrows 50 (not all arrows 50 are labeled, for clarity of illustration). It can be seen, for example, that pager 10(3) can communicate directly with pagers 10(4), 10(6) and 10(7), and that pager 10(10) can communicate directly with pagers 10(6), 10(7), 10(8), 10(9) and 10(11).

It can also be seen in the embodiment of FIG. 3 that pager 10(7) can communicate directly with any other pager 10(3)-10(11). Therefore, if 2-way pager 10(7) acts as a repeater, any of pagers 10(3)-10(11) can communicate with each other through 2-way pager 10(7). For example, 2-way pager 10(7), acting as a repeater, allows pager 10(3) to communicate with any of pagers 10(5), 10(8), 10(9), 10(10) and 10(11). When pager 10(3) communicates with pager 10(8), for example, the steps involved are: (1) Pager 10(3) sends a page; (2) pager 10(7) detects the page and repeats the page; (3) pager 10(8) detects the page, alerts a user of pager 10(8) and sends a first confirmation that the page was detected; (4) pager 10(7) detects the first confirmation and repeats it, (5) pager 10(3) detects and displays the first confirmation; (6) the user of pager 10(8) presses, for example, the “ID advance” button 22(1) to confirm displaying the page, and pager 10(8) sends a second confirmation acknowledging that the user has displayed the page; (7) pager 10(7) detects the second confirmation and repeats it; and (8) pager 10(3) detects and displays the second confirmation.

2-way pagers may transmit and receive pages using one or more frequencies within the frequency range 150 MHz to 900 MHz, although other frequencies may be used in certain cases.

A transmission collision occurs when two users of 2-way pagers 10 press the page button at about the same time, so that the resulting transmissions overlap; the pages transmitted may not be received correctly, in which case a receiving 2-way pager 10 will not respond to the page. The 2-way pagers 10 that originally sent the pages thus do not receive a ‘receive confirm’ message for the page, and in one embodiment, may wait for a random delay period and re-transmit the page. Also, if the 2-way pager does not indicate a read acknowledge for the page, the user may also re-send the page.

In one embodiment, a 2-way pager may indicate that a page is received by destination 2-way pager by displaying an icon on the display. This does not indicate that the user of the destination 2-way pager has read the page, but that it was received by the intended 2-way pager and is stored in its list of pages.

FIG. 4 is a flowchart of one exemplary process 100 of 2-way paging; process 100 is for example implemented by 2-way pager 10. Process 100 (and other modes illustrated in FIG. 5 through FIG. 8) may be executed, for example, by processor 14 of 2-way pager 10. Process 100 (and other modes illustrated in FIG. 5 through FIG. 8) includes decision points that may accept a “key sequence” from a user of 2-way pager 10(1); it is appreciated that while exemplary sequences of buttons (e.g., buttons 22, FIG. 1 or buttons 22(1)-22(3), FIG. 2A) are listed in some cases, such key sequences are exemplary only, that is, a 2-way pager 10 may accept sequences of buttons 22 as input even if they are different from those listed. Certain steps in process 100 (and other modes illustrated in FIG. 5 through FIG. 8) are enclosed within dashed rectangles to indicate that the steps so enclosed are optional to functionality of a 2-way pager 10.

Process 100 begins at a Start step 110. Step 120 accepts a key sequence to enter a learn mode 200: if the appropriate key sequence is entered by the user, process 100 enters learn mode 200 (see FIG. 5); otherwise process 100 enters step 130. Step 130 accepts a key sequence to enter a repeater mode 300: if the appropriate key sequence is entered by the user, process 100 enters repeater mode 300 (see FIG. 6); otherwise process 100 enters step 140.

Step 140 accepts a key sequence to toggle an alert mode of 2-way pager 10 between an audible mode and a vibrate mode. A given alert mode (audible mode or vibrate mode) of 2-way pager 10 may be stored in memory 26 so that the pager can come back up in the same mode even if powered down, or the alert mode may be determined by an active logic state while powered on, reverting to a default alert mode when the pager powers down. In step 140, if the appropriate key sequence is entered by the user, step 150 changes the current alert mode from audible to vibrate or from vibrate to audible (and may optionally store the current alert mode in memory 26), otherwise process 100 enters step 160.

Step 160 checks whether a confirmation has been received. If so, a confirmation LED (e.g., LED 24) is turned off 170; otherwise process 100 enters step 180. Step 180 checks whether a page has been received: if so, process 100 enters step 190, otherwise process 100 enters a send page mode 400 (see FIG. 7). Step 190 checks to see whether a received page is valid; for example, whether the format of the received page is valid (e.g., not corrupted by a transmission collision) and that the received page has a network ID that is the same as the 2-way pager 10 receiving the page (e.g., it is a page for the correct network, not a different network). If the received page is valid, process 100 enters a receive page mode 500, otherwise process 100 returns to step 110.

Dashed lines connecting learn mode 200, repeater mode 300, send page mode 400 and receive page mode 500 with Start step 110 indicate that each of these modes returns to Start step 110; the logic flows that affect these returns are illustrated in FIG. 5 through FIG. 8.

FIG. 5 is a flowchart of learn mode 200 of 2-way pager 10. Step 210 of learn mode 200 turns on a “Learn” icon (e.g., LCD icon 42(4), FIG. 2A) and resets ID digits to beginning characters of an ID digit sequence. For example, an ID digit sequence may include values of blank, 0 through 9 and/or A through Z in any order; step 210 resets each of the ID digits to whatever value is considered the first in the digit sequence. Step 220 scrolls the value of the first ID digit through the digit sequence in response to an appropriate key sequence (e.g., use of ID advance button 22(1), FIG. 2A). Step 230 accepts a key sequence that changes the digit being scrolled to the second (or subsequent) digit; in the absence of such a key sequence, learn mode 200 reverts to step 220. Step 240 scrolls the value of the second (or subsequent) ID digit through the digit sequence in response to an appropriate key sequence (e.g., use of ID advance button 22(1), FIG. 2A). Step 250 accepts a key sequence that indicates a user wishes to complete learn mode; in the absence of such a key sequence, learn mode 200 reverts to step 240. Step 260 checks the configuration of the 2-way pager 10's DIP switches (e.g., DIP switches 15, FIG. 2B). If the DIP switches are set to a configuration that corresponds with a pager ID learn mode, learn mode 200 enters step 270 that stores the currently displayed ID as the pager ID. If the DIP switches are set to any other configuration (e.g., a network configuration as discussed in connection with FIG. 2B), learn mode 200 enters step 280 that stores the currently displayed ID as a pagee ID. After either of steps 270 or 280, learn mode 200 enters step 290 that turns off the “Learn” icon and turns on a confirmation LED (e.g., LED 24, FIG. 2A). After step 290, 2-way pager 10 exits learn mode and returns to step 110 of process 100 (FIG. 4).

FIG. 6 is a flowchart of repeater mode 300 of 2-way pager 10. Step 310 of repeater mode 300 turns on a repeater icon (e.g., LCD icon 42(2), FIG. 2A). Step 320 accepts a key sequence to exit the repeater mode (e.g., pressing both ID advance button 22(1) and Code advance button 22(2), FIG. 2A, simultaneously). If such a sequence is received, repeater mode 300 enters step 330 that turns off the repeater icon, then returns to step 110 of process 100 (FIG. 4). If the key sequence to exit repeater mode is not received in step 320, step 340 checks to see if a page has been received. If no page has been received, repeater mode 300 returns to step 320. If a page is received, step 350 checks to see if the page is valid. If the page is not valid (e.g., it is corrupted by a transmission collision, or it is a page for a different network), repeater mode 300 returns to step 320. If the page is valid, step 360 repeats the page. It will be appreciated that when a 2-way pager 10 is in repeater mode 300, confirmations are repeated in the same manner as an original page. An optional step 370 waits for a predetermined delay and repeats the page; step 370 may increase chances of a page (or a confirmation) being successfully relayed in case a transmission error disrupts the first repetition of the page, or in case an intended pagee (or pager intended as recipient of a confirmation) is temporarily out of range. After step 370 (or step 360, if step 370 is omitted) repeater mode 300 returns to step 320.

FIG. 7 is a flowchart of send page mode 400 of 2-way pager 10. Send Page mode 400 allows a user of 2-way pager 10 to compose a page by selecting information displayed on display 20, then sending the page. Step 410 of send page mode 400 accepts a key sequence (e.g., Page button 22(3), FIG. 2A) to send a page that is currently displayed on display 20. If the key sequence is received, send page mode 400 enters step 460 (described below), otherwise send page mode 400 enters step 420, which accepts a key sequence (e.g., ID advance button 22(1), FIG. 2A) to advance a pagee ID displayed in display 20. If the key sequence to advance a pagee ID is received in step 420, send page mode 400 enters step 430, which advances the ID digits of display 20 to display another stored pagee ID in the pagee ID list (as discussed in connection with FIG. 1), then returns to step 410. If the key sequence to advance a pagee ID is not received in step 420, send page mode 400 enters step 440, which accepts a key sequence (e.g., Code advance button 22(2), FIG. 2A) to advance a page code displayed in display 20. If the key sequence to advance a page code is received in step 440, send page mode 400 enters step 450, which displays another page code stored in the code list (as discussed in connection with FIG. 1) in display 20, then returns to step 410.

Once a user is satisfied with a page displayed in display 20 and presses the appropriate key sequence to send a page, send page mode 400 enters step 460, which transmits a page that includes a network ID (as set by DIP switches 15, FIG. 1 and FIG. 2B or defined within memory 26 as network ID 13), the pager ID (e.g., the ID 27 (FIG. 1) stored in the sending 2-way pager 10), the currently displayed (in display 20) pagee ID (e.g., the ID 27 (FIG. 1) stored in the 2-way pager 10 intended to receive the page) and page code. The page may also, optionally, include date and/or time information of the sending 2-way pager 10. An optional step 465 moves the page code of the transmitted page to the front of a stored page code list of 2-way pager 10 (as discussed in connection with FIG. 1). Optional step 470 waits for a confirmation to be received, and when a confirmation is received optional step 480 turns on a confirmation LED of the sending 2-way pager 20. After step 460 and/or optional steps 470 and 480, send page mode 400 returns to step 110 of process 100 (FIG. 4).

FIG. 8 is a flowchart of receive page mode 500 of 2-way pager 10. Step 510 of receive page mode 500 adds a newly received page (which was confirmed as valid in step 190, process 100) to the received page list of 2-way pager 10. An optional step 520 sends a page received confirmation and issues an alert which may be audible (e.g., a beep, or an audible signal that can convey information about the page code by varying pitch, tone, type and/or sequence of sounds) or tactile (e.g., the pager may vibrate). An optional step 530 turns on an unacknowledged page icon (e.g., LCD icon 42(1), FIG. 1) and places part or all of display 20 in a blinking mode. Step 540 displays the most recent unacknowledged page in display 20. Step 550 accepts a key sequence (e.g., ID advance button 22(1), FIG. 2A) to advance the displayed page. If the key sequence to advance the displayed page is received, receive page mode 500 enters step 560, otherwise it reverts to step 540. Step 560 sends an acknowledgement of the current page, and an optional step 570 changes the current page status to “acknowledged” in the received page list, and turns off the (optional) unacknowledged page icon. Step 580 reviews the received page list to determine whether “unacknowledged” pages remain in the received page list; if so, step 590 displays the next unacknowledged page in the list, and receive page mode 500 reverts to step 540. If no “unacknowledged” pages remain in the received page list, an optional step 600 turns off the blinking mode of display 20, an optional step 610 displays the most recent page, and receive page mode returns to step 110 of process 100 (FIG. 4).

The page code, formed of two alpha-numeric digits, may also be interpreted as a location code and an action code. The first digit may be considered as the location and the second digit may be considered as the action. The location and actions codes are known to all users of the 2-way pager, such that upon receiving the page code, they may interpret the code.

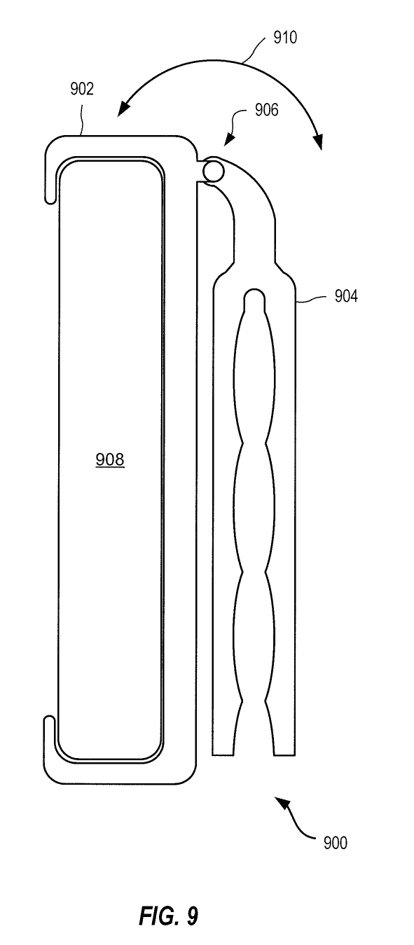

FIG. 9 shows a 2-way pager 908 with an attached belt clip 900. Pager 908 is secured within a pager bracket 902 that securely holds pager 908. A clip 904, suitable for attaching to a belt or clothing, is attached to bracket 902 by a pivot 906. Pivot 906 allows bracket 902 to rotate, as shown by arrow 910, while clipped to a belt or clothing such that the display (e.g., display 20) of pager 908 may be easily viewed without detachment. For example, pager 908 may be inverted within bracket 902 such that pager 902 is readable when rotated and while still attached to clothing (e.g., while attached to a belt). Belt clip 900 also facilitates single handed operation of 2-way pager 908.

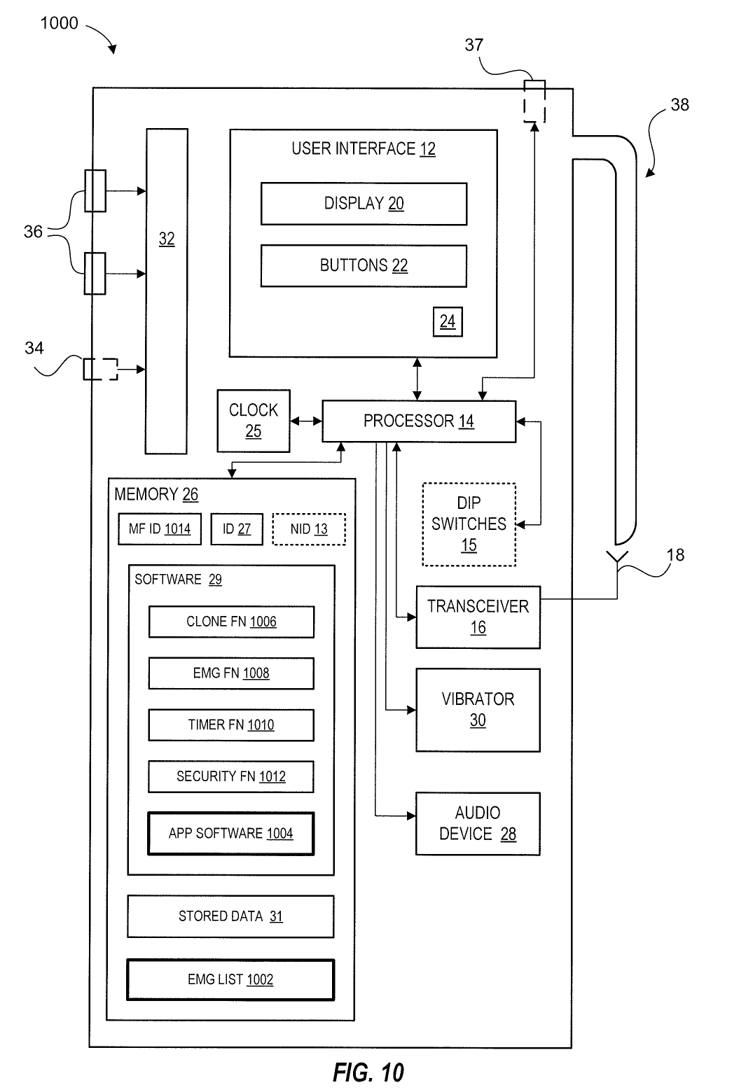

FIG. 10 shows an embodiment of a 2-way pager 1000, similar to 2-way pager 10(1) of FIG. 1. Power connections from power source 32 to each powered element of 2-way pager 1000 are not shown for clarity of illustration. 2-way pager 1000 includes an emergency page function 1008, an emergency page list 1002, a clone function 1006, a timer function 1010, a security function 1012 and application software 1004. Clone function 1006, emergency page function 1008, timer function 1010, security function 1012 and application software 1004 are shown within software 29, and may represent software applets of 2-way pager 1000. Emergency page list 1002 is shown within memory 26 and contains a list of pager IDs to receive emergency pages should the emergency page function 1008 of pager 1000 be initiated by a user. For example, the user invokes the emergency page function 1008 using one or more of buttons 22, such as by pressing and holding any of buttons 22, FIG. 2A, for two seconds. Emergency page function 1008 then pages each pager listed within emergency page list 1002 with a predefined emergency page code.

Each pager receiving the emergency page generates an alert (e.g., audio and/or vibratory) and displays the emergency page code and automatically acknowledges receipt of the emergency page. In an embodiment, the 2-way pager 1000 sending the emergency page periodically repeats the emergency page to listed pagees that do not acknowledge receipt of the emergency page.

In one embodiment, emergency page list 1002 is pre-configured for operation of a group of 2-way pagers 1000 within a particular network. That is, emergency page list 1002 of each 2-way pager 1000 of the group may be pre-configured with IDs of certain other 2-way pagers within the group. For example, within a medical environment, pagee IDs of key personnel may be listed in emergency page list 1002 such that these personnel may be quickly summoned in an emergency.

Application software 1004 may include functionality specific to one particular use of 2-way pager 1000. That is, basic functionality of 2-way pager 1000 and associated software located within software 29 of memory 26 may remain consistent for 2-way pager 1000; however, application software 1004 may be provided to add functionality to 2-way pager 1000, beyond the basic functionality provided by software 29, where a particular group of users requires this additional functionality. Thus, application software 1004 may include additional features desired by the group of users without requiring modification of software 29. Computer interface port 37 may facilitate programming of special application software 1004 to memory 26.

Cloning function 1006 allows configuration information (e.g., stored data 31) of a first 2-way pager 1000 to be replicated into one or more second 2-way pagers. In one example of operation, a unique pager ID is first configured on each 2-way pager 1000 clone (see for example FIGS. 4 and 5). Then, each 2-way pager 1000 clone is configured into a ‘clone receive mode’, for example by utilizing a unique key sequence. That is, a key sequence on 2-way pager 1000 invokes functionality within clone function 1006 to initiate a clone receive mode. Then, 2-way pager 1000 to be cloned is set into a ‘clone transmit’ mode, for example by initiating clone transmit functionality of clone function 1006 using a unique key sequence. The 2-way pager 1000 then transmits information from stored data 31 and emergency page list 1002 which is received by each 2-way pager 1000 in range. The 2-way pagers 1000 set to clone receive mode are thus updated to include similar configuration to the transmitting 2-way pager. Since pagee lists within stored data 31 and emergency page list 1002 may include the ID of a receiving 2-way pager, functionality of clone function 1006 replaces, within the receiving 2-way pager, this ID with that of the transmitting 2-way pager, thereby making the lists operational within the receiving 2-way pager. A network of 2-way pagers 1000 may thus be easily be configured from a first 2-way pager.

Timer function 1010, shown within software 29, allows 2-way pager 1000 to provide a countdown timer function. Timer function 1010 is initiated by a unique key sequence whereupon buttons 22 allow the user to start, stop, reset and set a start time on display 40. For example, an action button 22 may be used to step through the sequence ‘00’, ‘15’, ‘30’ and ‘45’ to allow times to be entered easily. In countdown mode, 2-way pager 1000 decrements the set time until zero is reached, whereupon an alert (e.g., a beep from audio device 28 or vibration from vibrator 30) is issued. Operation of timer function 1010 does not interfere with normal paging operation of 2-way pager 1000. That is, once the countdown timer has been started, display 20 may return to normal pager operation to display received pages and to allow pages to be sent from 2-way pager 1000.

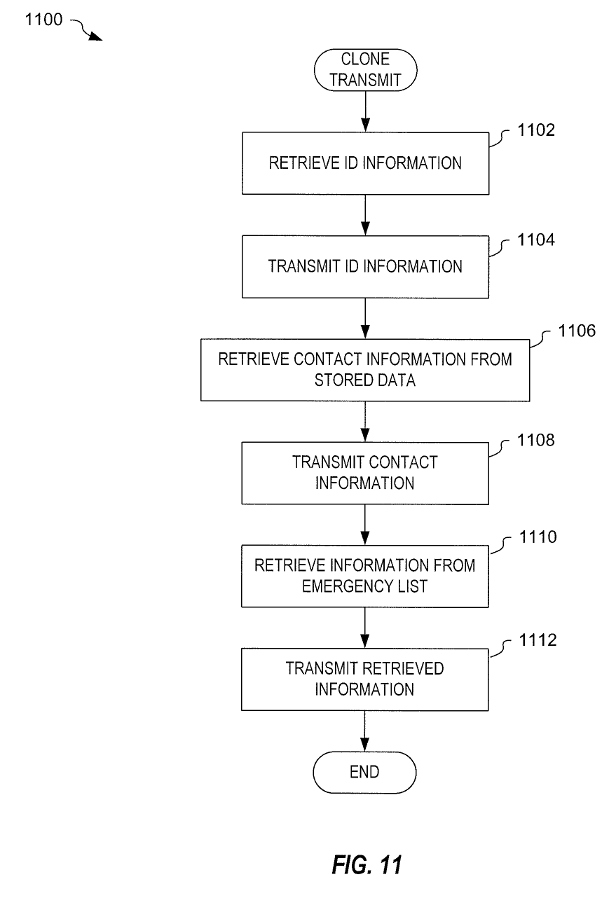

FIG. 11 shows one exemplary process for transmitting cloning information from a 2-way pager. Process 1100 is implemented within clone function 1006 of 2-way pager 1000, for example. In step 1102, process 1100 retrieves ID information of the 2-way pager. In one example of step 1102, clone function 1006 retrieves ID 27 from memory 26. In step 1104, process 1100 transmits the ID information. In one example of step 1104, clone function 1006 utilizes transceiver 16 to transmit ID 27. In step 1106, process 1100 retrieves contact information from stored data. In one example of step 1106, clone function 1006 retrieves contact information from stored data 31. In step 1108, process 1100 transmits the contact information. In one example of step 1108, clone function 1006 utilizes transceiver 16 to transmit the contact list retrieved from stored data 31. In step 1110, process 1100 retrieves information from the emergency page list. In one example of step 1110, clone function 1006 retrieves information from emergency page list 1002. In step 1112, process 1100 transmits the emergency page list 1002 information retrieved in step 1110. In one example of step 1112, clone function 1106 uses transceiver 16 to transmit the data retrieved from emergency page list 1002. Process 1100 then terminates and 2-way pager 1000 returns to operation of receiving and sending pages.

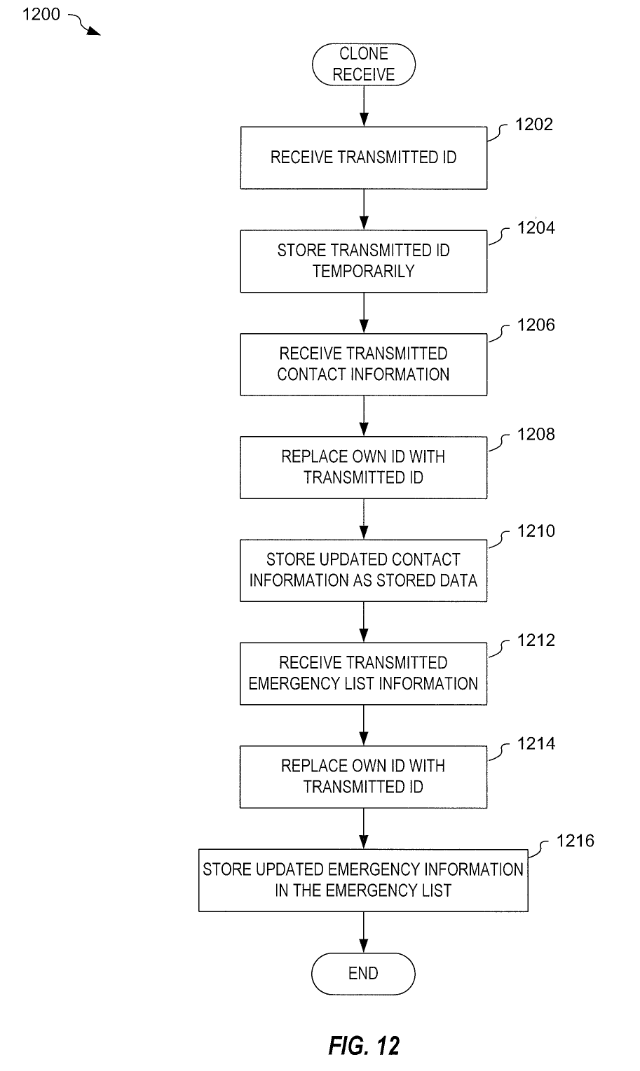

FIG. 12 shows one exemplary process 1200 for receiving cloning information within 2-way pager 1000. Process 1200 is implemented within clone function 1006 of 2-way pager 1000, for example. In step 1202, process 1200 receives the transmitted ID of process 1100. In one example of step 1202, clone function 1006 receives ID 27 of the transmitting 2-way pager from transceiver 16. In step 1204, process 1200 temporarily stores the received ID. In one example of step 1202, clone function 1006 stores the received ID within a register of processor 14. In step 1206, process 1200 receives transmitted contact information. In one example of step 1206, clone function 1006 uses transceiver 16 to receive contact data transmitted by process 1100 in step 1108. In step 1208, process 1200 replaces entries within the received contact information that have their own IDs with the temporarily stored ID (step 1204). In one example of step 1208, clone function 1006 searches the received contact information to identify an entry that matches ID 27 within memory 26, and then replaces the ID stored within the matched entry with the temporarily stored ID received from the transmitter. In step 1210, process 1200 stores the updated contact information as stored data. In one example of step 1210, clone function 1006 stores the updated contact information within stored data 31. In step 1212, process 1200 receives emergency page list information transmitted from step 1112 of process 1100. In one example of step 1212, clone function 1006 receives, via transceiver 16, emergency page list information. In step 1214, process 1200 updates the received emergency page list by replacing entries having their own IDs with the temporarily stored ID received in step 1202. In one example of step 1214, clone function 1006 replaces any entry within the received emergency page list that matches ID 27 of its 2-way pager 1000 with the ID received in step 1202. In step 1216, process 1200 stores the updated emergency page list of step 1214 in the emergency page list. In one example of step 1216, clone function 1006 stores the updated emergency contact information within emergency page list 1002. Process 1200 then returns to normal page receive and send operations.

In an embodiment, 2-way pager 1000 connects to a computer via computer interface port 37 such that the connected computer may utilize 2-way pager 1000 to send and receive pages, created and displayed, respectively, on the computer. In one example, the computer runs software to facilitate control and configuration of 2-way pager 1000. In an embodiment, computer interface port 37 facilitates update of software 29 of pager 1000 from the connected computer (for example through downloading software from a web site).

In an embodiment, 2-way pager 1000 uses a security function 1012 (shown within software 29) that prefixes each transmission (e.g., sent pages and acknowledgements) from 2-way pager 1000 with a manufacturer's ID 1014, network ID (determined from DIP switches 15 or network ID 13 of memory 26), ID 27 (i.e., the ID of the sending pager) and operational codes (e.g., a code that provides indication if the page is an emergency page or a normal page, an acknowledgement to a page, etc.). Each message (e.g., page, emergency page, acknowledgement, etc.) received by 2-way pager 1000 is accepted only if the manufacturer's ID and network ID of the received message match manufacturer's ID 1014 and the network ID (e.g., as defined by DIP switches 15 or network ID 13); otherwise the received message is ignored by 2-way pager 1000. The received operational codes define the appropriate action by 2-way pager 1000 in response to the received message. For example, if the operational codes of the received message indicate that it is an emergency page, the emergency page is displayed and an appropriate annunciation made using one or both of vibrator 30 and audio device 28, thereby alerting the user of 2-way pager 1000 to the received emergency page.

In another embodiment, display 20 of 2-way pager 1000 includes text capability that permits text pages (i.e., not just ID and page code) to be sent and received. Buttons 22 of 2-way pager 1000 allow the user to scroll through characters and numbers to select desired characters to construct a text page. One embodiment allows the user to operate the pager with one hand which allows the user to have one hand available even when making or receiving pages.

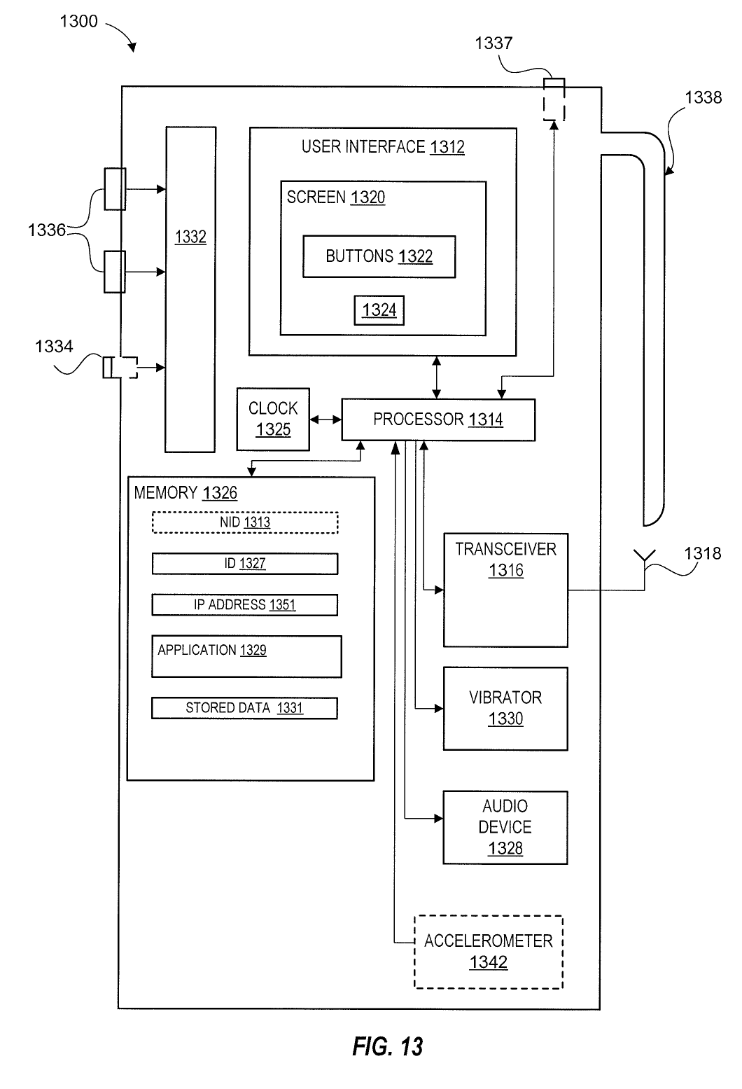

FIG. 13 shows one exemplary 2-way pager application 1329 operating on a wireless device 1300. Application 1329 represents application software 29 of FIGS. 1 and 10 that is ported to operate on wireless platform 1300 (e.g., an iPhone™ and an iTouch™ manufactured and sold by Apple™). 2-way pager application software 1329 may be loaded in device 1300 memory 1326 via a USB interface port 1337 or downloaded wirelessly by way of the Internet via a transceiver 1316 within wireless device 1300. Transceiver 1316 for example receives data corresponding to application software 1329 to device 1300 via an antenna 1318. In one example, application 1329 is purchased online and downloaded from the Apple™ website into memory 1326 of wireless device 1300. In another example, application 1329 is purchased online and downloaded from the Apple™ website into a memory of a personal computer. Once stored within memory 1326, application 1329 may be executed by a processor 1314 of wireless device 1300 thereby operating device 1300 in a manner similar to 2-way pager 10(1) of FIG. 1 and 2-way pager 1000 of FIG. 10. That is, device 1300 under control of application 1329 may include some or all of the features of pager 10(1) (FIG. 1), and pager 1000 (FIG. 10).

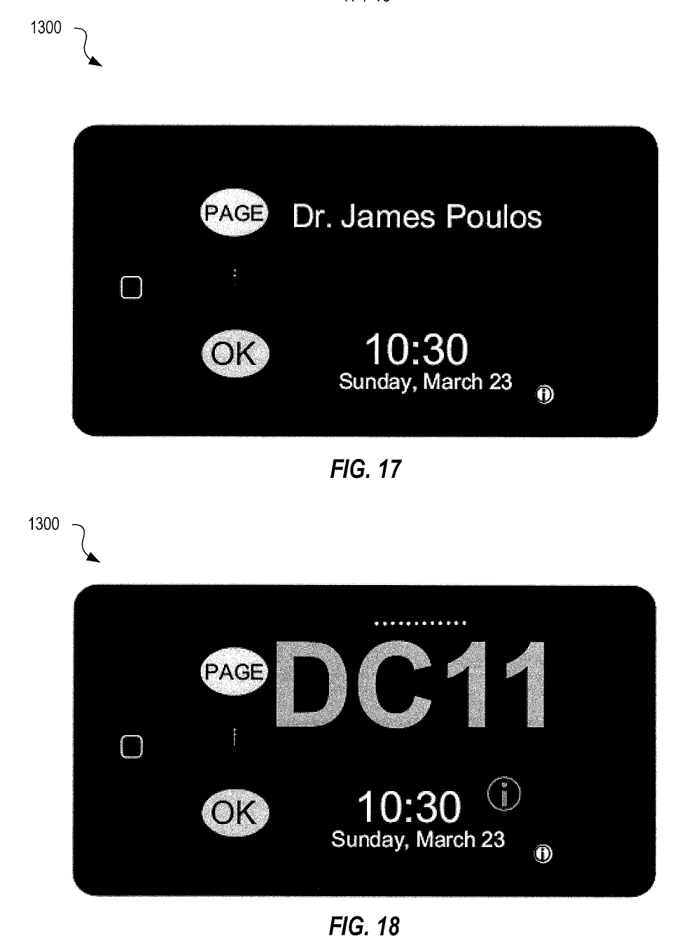

Device 1300 is shown with a user interface 1312 that includes an integrated multi-touch screen 1320 with virtual keyboard and buttons that respond to user input for managing, displaying and/or sending information. Application 1329 utilizes user interface 1312 to interact with a user. For example, application 1329 configures screen 1320 with touch-screen buttons 1322 that the user may touch to set up and/or send a page to another 2-way pager, or that the user may press to display and/or acknowledge a page received from another 2-way pager. User interface 1312 may also allow a user to attach other electronic files to a page. For example, user interface 1312 may allow a user to attach a text file, an audio file, a video file, or any other electronic file, to a page to be sent to another 2-way pager. In one example of operation, a user attaches a digital x-ray to a page, and then sends that page to a destination 2-way pager. Screen 1320 may display numeric, alphanumeric and/or graphical information to the user. Exemplary screen shots of user interface 1312 configured for user interaction with application 1329 are shown in FIGS. 17-20 and described below. Optional indicators 1324 (e.g., page received confirmation indicator 24, FIG. 2) may be displayed upon screen 1320 by application 1329 to indicate status information of application 1329 (e.g., to indicate when a page sent from device 1300 is acknowledged).

As noted above, application 1329 is stored in memory 1326 such that, upon execution by processor 1314, application 1329 implements the 2-way pager functionality of pager 10(1) of FIG. 1 and pager 1000 of FIG. 10, described herein. Memory 1326 may also store information of application 1329, such as an ID 1327 that is assigned to device 1300 by the user (or a system administrator), and stored data 1331 that may include lists of pages received, IDs of pagees within a network, network information (e.g., a network ID 1313), and codes representing page code used by wireless devices operating application 1329 (i.e., 2-way pagers) within the network.

Within device 1300, transceiver 1316 provides WiFi connectivity within wireless networks and to other wireless devices. That is, application 1329 may utilize transceiver 1316 to communicate with other wireless devices functioning as 2-way pagers. In one example, application 1329 utilizes the IEEE 802.11 wireless protocol to communicate with other wireless devices operating as 2-way pagers (e.g., other iPhones or iTouch wireless devices running application 1329). WiFi typically operates in either the 2.4 GHz or the 5 GHz frequency band using 802.11b or 802.11g protocols with a communication range of 120-300 ft. Application 1329 may control device 1300 to operate as a repeater device to relay transmissions from other wireless devices operating as 2-way pagers, thereby increasing the operational area of a 2-way paging network formed therefrom.

In one embodiment, application 1329 controls device 1300 to form continuous links with other wireless devices controlled by application 1329 that are within range (“link mode”), thereby forming a 2-way pager network. By configuring one or more devices 1300, under control of application 1329, in the 2-way pager network to operate as a repeater, communication links may be formed between wireless devices that are not in direct wireless communication range. When operating in this link mode, devices 1300 periodically broadcast their IP address 1351 and ID 1327. Each device 1300 that receives this broadcast stores the received IP addresses and IDs 1327 within memory 1326 (e.g., within stored data 1331) to form a lookup table for example. This broadcast may also include a network ID 1313 such that wireless devices having the same network ID form a 2-way pager network (i.e., the received ID 1327 and IP address from the broadcast is only stored within memory 1326 if the received network ID matches the network ID 1313 already stored within memory 1326). The use of network ID 1313 allows multiple 2-way pager networks to be formed within the same area without confusion between transmitted and received pages of each network.

Since each device 1300 within the 2-way pager network constructs a lookup table containing the IP addresses of other devices within the 2-way pager network, it may form a network communication channel directly to a destination wireless device when communicating therewith. That is, application 1329 controls device 1300 to form a WiFi communication channel directly with another wireless device (e.g., based upon IP address of the destination device) within the 2-way pager network when communication is required with that device.

In an alternative embodiment, application 1329 controls device 1300 to broadcasts each message (including an associated IP address 1351 and ID 1327), and a direct communication link between two wireless devices is not formed (“broadcast mode”). In broadcast mode, when a page is received by device 1300, processor 1314, under control of application 1329, compares the received pagee ID with the pager ID 1327 within memory 1326. If the pagee ID is the same as ID 1327, device 1300 is the recipient of the transmitted page, and the user of device 1300 is notified of the received page. For example application 1329 may display an indicator 1324 and use zero, one or both of a vibrator 1330 and an audio device 1328 of device 1300 to indicate the arrival of the received page. Such indication (visual, vibratory and/or audio) may also be generated to indicate that a page sent from device 1300 has been acknowledged by the receiving device.

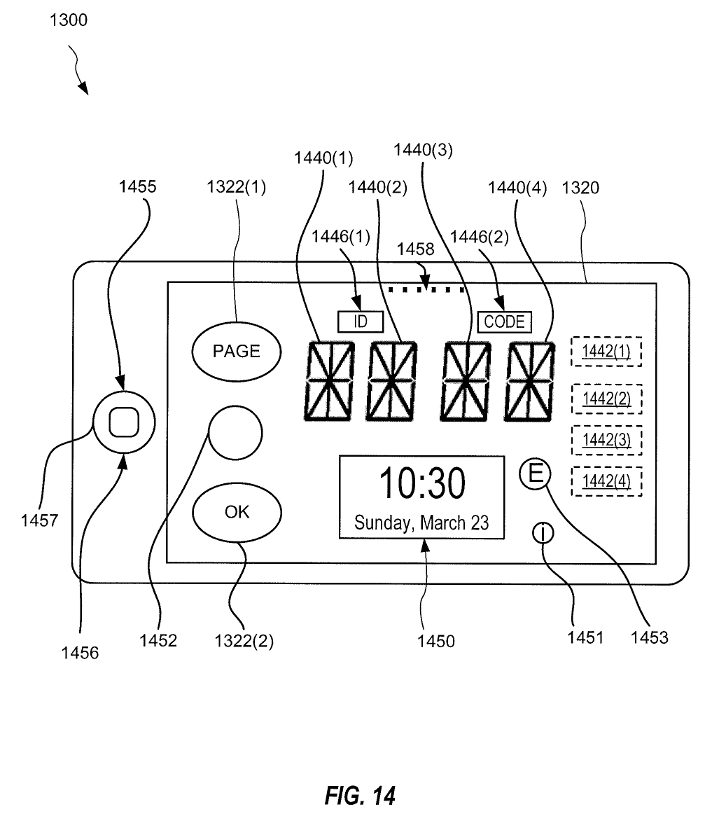

In one example of operation, a user sends a page from device 1300 to a second device by interacting with user interface 1312 to (a) select a pagee ID (i.e., the ID of the device to be paged) from a list of pagee IDs and/or (b) select a page code from a list of page codes stored within memory 1326 of device 1300. The user may then press a page button 1322 (see FIG. 14) to send the page containing the selected page code to the selected pagee. When operating in link mode, application 1329 looks up the selected pagee ID to determine the IP address of the destination device, forms a communication link from device 1300 to the destination device using determined IP address, and then sends the page to the destination device. The sent page may include the IP address 1351 and ID 1327 of device 1300 (i.e., the sending device), the selected pagee ID, the selected page code, date/time information (e.g., as maintained within device 1300), and optionally a network ID 1313.

Device 1300 may also include a 3-axis accelerometer 1342 that measures acceleration and gravity induced reaction forces such as caused by device orientation (i.e., gravity), vibration, and shock. In one embodiment, application 1329 utilizes information from accelerometer 1342 to determine orientation of device 1300 and may determine whether the user of device 1300 is left-handed or right-handed.

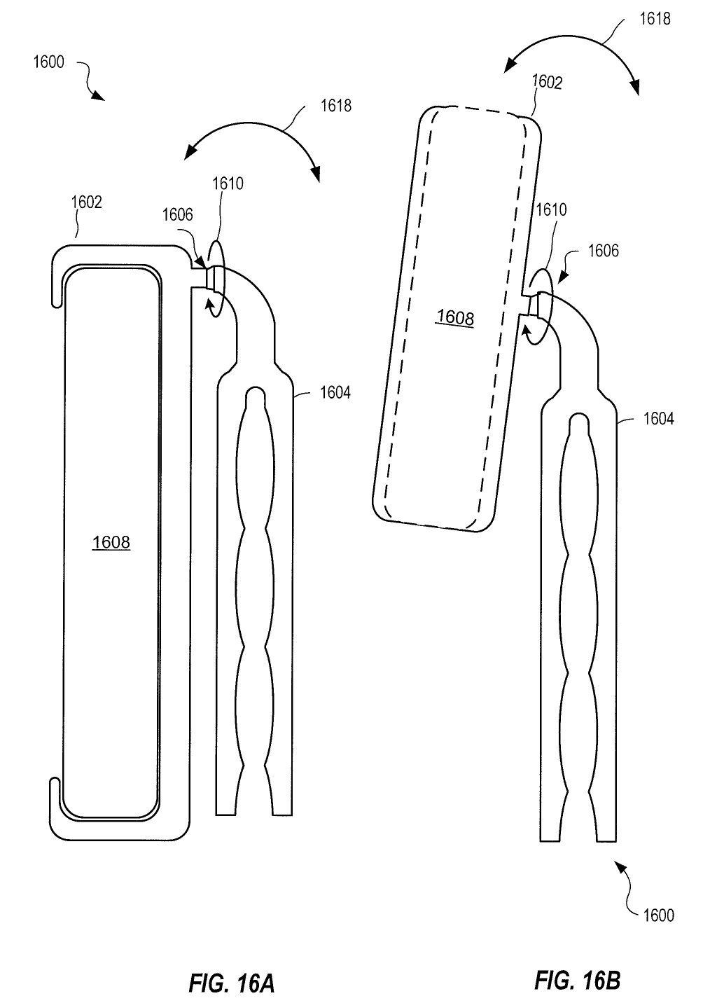

Device 1300 may connect to a configuration device (e.g., a personal computer) via interface port 1337 (e.g., a USB port) for transfer of application 1329 to memory 1326 and configuration of ID 1327, network ID 1313, IP address 1351 and stored data 1331 within memory 1326. Device 1300 may also include elements (e.g., a belt hook 1338) for attaching device 1300 to clothes of the user. See also FIG. 16A and FIG. 16B. A power source 1332 (such as one or more AAA batteries) may power device 1300. Device 1300 optionally includes an input power socket 1334 and/or battery contacts 1336 for recharging power source 1332 and/or for operating device 1300 from an external power source.

FIG. 14 shows one exemplary front view of device 1300 of FIG. 13, where device 1300 represents an Apple™ iPhone™. FIGS. 13 and 14 are best viewed together with the following description. Device 1300 is shown configured by application 1329 as a left-handed device with touch screen buttons 1322 presented on the left side of screen 1320. If application 1329 determines that the user is right-handed, application 1329 may configure touch screen buttons 1322 on the right side of screen 1320. Application 1329 may also be configured to operate as only a left-handed or right-handed device, thereby ignoring orientation information from accelerometer 1342.

Information from accelerometer 1342 may be used by application 1329 to determine orientations of device 1300 and thereby orient displayed information of screen 1320 accordingly. In one example of operation, application 1329 may determine left-handed operation when accelerometer 1342 senses that device 1300 is being accelerated such that a fixed navigation button 1457 is located on the left side of device 1300. Similarly, device 1300 may be oriented in a right-handed orientation when accelerometer 1342 senses that device 1300 is accelerated such that navigation button 1457 is located on the right side of device 1300.

Screen 1320 is shown displaying LCD numerals 1440(1) and 1440(2) that represent an ID, and LCD numerals 1440(3) and 1440(4) that represent a page code. Device 1300 is shown in PAGE mode wherein touch-screen button 1322(1) is a “Page” button and touch-screen button 1322(2) is an “OK” button. Pressing “Page” button 1322(1) in PAGE mode notifies application 1329 to present the next most frequent contact ID on screen 1320 using LCD numerals 1440(1) and 1440(2). The user of device 1300 may acknowledge receipt of a page by pressing “OK” button 1322(2). A received page may also be acknowledged by touching the ID on screen 1320 (e.g., numeral 1440(1) and/or 1440(2)), which may be configured to operate as a button. For example, numerals 1440(1) and/or 1440(2) in PAGE mode may also be configured to allow the user to scroll through IDs based upon ID lists within stored data 1331. Similarly, numerals 1440(3) and/or 1440(4) in PAGE mode may be configured to allow the user to the scroll through available pages codes stored in memory 1326.

Pages may be stacked (e.g., stored in a list in the order received) and indicated by a dotted line 1458. Accessing stacked pages may be accomplished by pressing fixed navigation button 1457. For example, a user may press navigation button 1457 at pressure point 1455 to page up. Similarly, the user may press navigation button 1457 at pressure point 1456 to page down. Navigation button 1457 may be physically built into device 1300. The arrival time 1450 (illustrated as “10:30 Sunday March, 23”) includes both the date and time that the displayed page was received.

Device 1300, under control of application 1329, may also display LCD icons 1442(1)-1442(4). LCD icon 1442(1) may indicate that pages received by device 1300 are not yet acknowledged. LCD icon 1442(2) may indicate whether pager 1400 is functioning as a repeater. LCD icon 1442(3) may indicate a condition of power supply 1332. LCD icon 1442(4) may indicate when device 1300 is in “Learn” mode (see FIGS. 4 and 5 and accompanying description).

Other indicia such as, for example, indicia 46(1)-46(5) (FIG. 2), may be displayed upon screen 1320 under control of application 1329. Indicia 1446(1)-1446(2) may help the user understand the meaning of displayed data and help the user to understand the function of device 1300; such indicia may also be customized for a specific application. For example, indicia 1446(1) may display the mnemonic “ID” to indicate that an ID is displayed by LCD numerals 1440(1)-1440(2), and indicia 1446(2) may display the word “CODE” to indicate that a page code is displayed by LCD numerals 1440(3)-1440(4). It is appreciated that other indicia 1446 may also be displayed without departing from the scope hereof. Where device 1300 is an iPager, application 1329 may utilize the enhanced functionality of user interface 1312.

An information icon 1451 allows the user to add, change or delete contact IDs, personal ID, personal notification, network IP addresses and emergency page lists. Personal notification is a method by which the pagee is notified of the arriving page by his or her pager. For example, a notification may be one or more of an audible sound, a vibration, or a visual indication on the pager. In an embodiment, a pagee may choose a notification of one beep, two beeps, three beeps, vibrate, beep and vibrate, or visual only (silent).

In one embodiment, touching “OK” button 1322(2) for two seconds causes application 1329 to send an emergency page to recipients listed on an emergency page contact list (e.g., emergency page list 1002, FIG. 10). Devices receiving an emergency page may display an emergency page indicia 1453 indicating that an emergency page has been received and may use one or both of vibrator 1330 and audio device 1328 to attract the user's attention. Emergency page indicia 1453 may be displayed on screen 1420 in flashing red color, or other eye-catching attributes (e.g., flashing LCD numerals 1440(3)-1440(4) to highlight the displayed page code).

Other functionality of application 1329 may be controlled from user interface 1312. For example, multiple countdown timers may be set by touching a timer icon 1452. Time may be set by touching minutes or seconds on screen 1320. OK button 1322(2) may be touched at any time to cancel the timer. Stacking icon 1458 may be used to indicate the number of timers currently active.

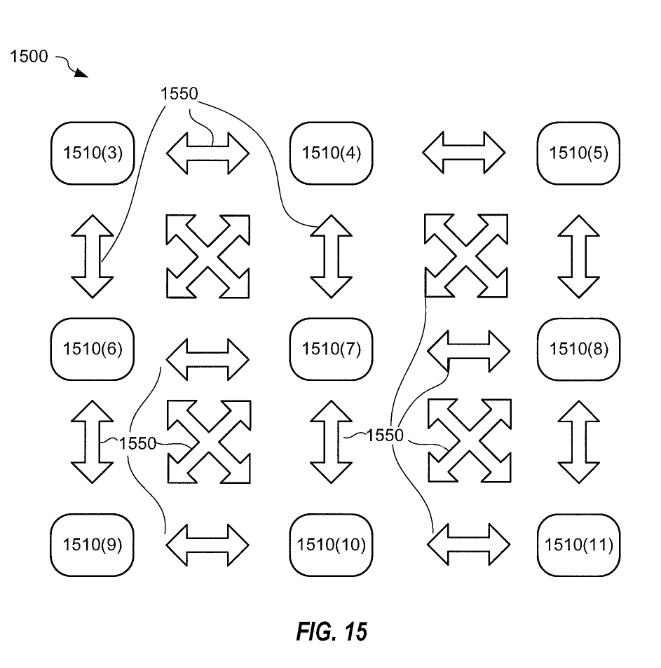

FIG. 15 shows one exemplary 2-way pager network 1500, illustrating how wireless devices 1510, under control of application 1329, operate as 2-way pagers (e.g., pager 1300, FIGS. 13 and 14) and communicate within 2-way pager network 1500. In the example of FIG. 15, network 1500 operates without a wireless access point (i.e., as an Ad hoc network). Each device 1510 discovers other devices 1510 within communication range (indicated by arrow 1550) to form network 1500. Application 1329 may control device 1510 to search for other wireless devices that are out of direct wireless communication range by sending a broadcast message that is forwarded (i.e., re-transmitted) by each device 1510 receiving the broadcast message. For example, in link mode, application 1329 may control device 1510 to broadcast its IP address 1351 and ID 1327. A second device 1510 receiving the broadcast message stores the received IP address and ID within its memory 1326. The second device 1510, under control of application 1329, may then transmit pages (and other messages) to the first device using the stored IP address. The second application 1329 may only transmit a message if the device 1510 IP address and ID 1327 were received within a given timeframe. For example, if more than one second has elapsed since the stored IP address and ID were received, then application 1329 may assume that the device is no longer within local network 1500 and may not transmit a message. Further, if a page confirmation is not received by the pager, the pager may retransmit the page on the local network; if there is no response to this retry, the pager may generate a message to indicate to the user that the destination pager is not on the network or is out of communication range.

In addition to storing the received IP address and ID of the first device, second device 1510 retransmits the received IP address and ID, thereby extending the area of coverage of 2-way pager network 1500. A third device 1510 receives the retransmitted message and stores the received IP address and ID of the first device 1510. Thus, even if the first and third devices 1510 are not be within direct wireless communication range of each other, they can still communicate via the second device 1510. Connections may therefore be formed between devices that are not in direct wireless communication with one another by using intermediate devices to relay the message, thus forming and operating a multi-hop ad hoc network. Routing protocols may be used to provide stable connections even if the wireless devices are mobile (i.e., are moving around).

In one example of operation, device 1510(3) sends a page to device 1510(11); however, device 1510(11) is not within direct wireless communication range of device 1510(3). Device 1510(3) broadcasts the page, which is received by devices 1510(4), 1510(6) and 1510(7). Each device receiving the broadcast page then rebroadcasts it. Since device 1510(11) is within direct wireless communication range of device 1510(7), it receives the rebroadcast page from device 1510(7).

In an alternate embodiment, local network 1500 may include one or more wireless access points (not shown) that manage network operation within their wireless communication range (infrastructure mode). Although within infrastructure mode, most communications are made via the wireless access point, devices 1510 may still operate as repeaters to extend the communication range of network 1500. Signal repeaters (not shown) such as the Apple™ Airport Express™ may also be included within network 1500 to extend the communication range and increase reliability of network 1500. In this embodiment, wireless access points may retransmit pages that are not acknowledged by the pagee. For example if a page is sent and no response or acknowledge from the pagee is received, then the access point may automatically retransmit the page. If no response is received for the retransmission (or a defined number of retransmission attempts), the access point may generate a message indicating that the pagee is not connected to the network or is not in communication range and then send that message to the originating pager.

FIGS. 16A and 16B show side views of one exemplary belt-clip 1600 for holding a wireless device 1608 (e.g., an Apple™ iPhone™) running application 132 (FIG. 13) to operate as a 2-way pager. Device 1608 may represent device 1300 of FIG. 13. Device 1608 is secured within a pager bracket 1602 that is attached, by a flexible joint 1606, to a clip 1604 suitable for attaching to a belt or clothing. Flexible joint 1606 allows bracket 1602 to rotate, as shown by arrows 1610 and 1618 (and illustrated in FIG. 16B), while clipped to a belt or clothing such that the display (e.g., screen 1320, FIG. 13) of pager 1608 may be easily viewed without detachment.

Application 1329 controlling device 1608 has several unique features. For example, where device 1608 has an accelerometer (e.g., accelerometer 1342, FIG. 13), application 1329 may maintain readability of information on screen 1320 irrespective of orientation of device 1608. For example, application 1329 maintains orientation of information on screen 1320 when device 1608 is inverted within bracket 1602 and when device 1608 is rotated while still attached to clothing (e.g., while attached to a belt). Belt clip 1600 also facilitates single-handed operation of device 1608, since device 1608 may be mounted horizontally and flipped up for easy viewing without removing from the clip, or removal of the clip from the belt or clothing.

FIGS. 17-20 show front views of exemplary embodiment of an Apple™ iPhone™ wireless devices (i.e., device 1300, FIG. 13) operating, under control of application 1329, as a 2-way pager.

In particular, FIG. 17 shows an exemplary display of device 1300 operating in “Receive” mode and displaying the name of the user, “Dr. James Poulos” in this example, and the current date and time “10:30 Sunday, March 23.”

FIG. 18 shows an exemplary display of device 1300 operating in “Received Page” mode. In this example, the ID of the paging device is displayed as “DC,” the page code is displayed as “11,” and the current date and time is displayed as “10:30 Sunday, March 23.”

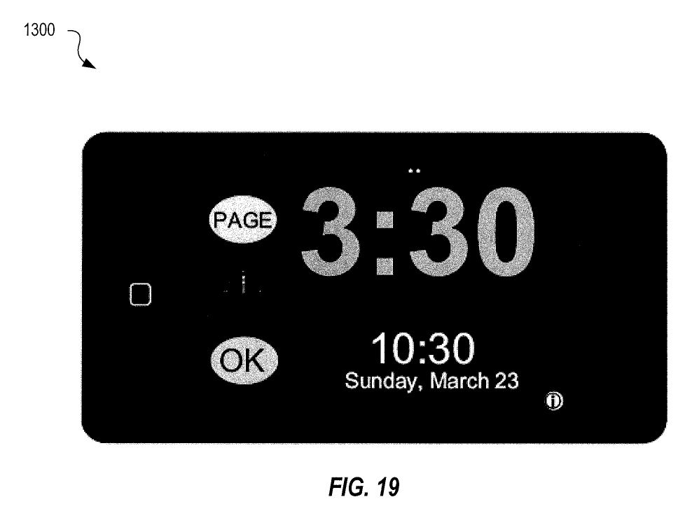

FIG. 19 shows an exemplary display for device 1300 operating in a “Timer” mode and displaying the time, “3:30” in this example, and the current date and time “10:30 Sunday, March 23.”

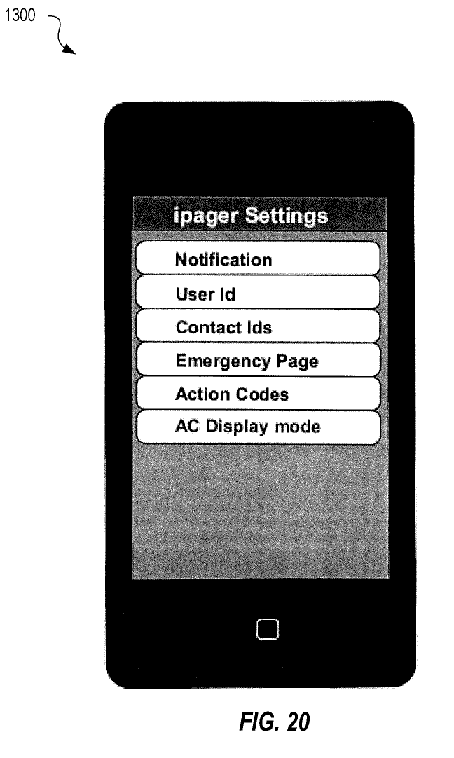

FIG. 20 shows an exemplary display for device 1300 operating in a “Pager Settings” mode. In this example, the user can select “Notification,” “User Id” “Contact Ids,” “Emergency Page,” “Action Codes,” or “AC Display mode.” A user may, for example, select “User Id” by pressing the “User Id” text on the screen. In this mode, the user can change the ID of the pager (e.g., ID 1327). The user may also select “Emergency Page” to send emergency pages, “Action Codes” to edit, modify, or view currently stores action codes, or “AC Display mode” to edit the devices display configuration. The displays of FIGS. 17-20 for example appear on screen 1320 (FIGS. 13 and 14).

Since certain changes may be made in the above methods and systems without departing from the scope of the disclosure herein, one intention is that all matter contained in the above description or shown in the accompanying drawings be interpreted as illustrative and not in a limiting sense. By way of example, those skilled in the art should appreciate that the 2-way pager described herein may be constructed, connected, arranged, and/or combined in ways that are equivalent to what is shown.

### REFERENCES

The following patents are incorporated herein by reference:

| U.S. Pat. No. | Issue month, year | Inventors |
|---|---|---|
| 4,041,389 | August, 1977 | Oades. |
| 4,198,600 | April, 1980 | Oguchi et al. |
| 4,284,848 | August, 1981 | Frost. |
| 4,556,865 | December, 1985 | Fukagawa et al. |
| 4,599,598 | July, 1986 | Komoda et al. |
| 4,701,935 | October, 1987 | Namiki. |
| 4,789,933 | December, 1988 | Chen et al. |
| 5,023,930 | June, 1991 | Leslie |
| 5,133,001 | July, 1992 | Bohm. |
| 5,252,979 | October, 1993 | Nysen. |
| 5,265,150 | November, 1993 | Helmkamp et al. |
| 5,321,736 | June, 1994 | Beasley. |
| 5,408,681 | April, 1995 | Ressler et al. |
| 5,424,859 | June, 1995 | Uehara et al. |
| 5,437,055 | July, 1995 | Wheatley, III. |
| 5,537,637 | July, 1996 | Sugita et al. |
| 5,577,265 | November, 1996 | Wheatley, III. |
| 5,752,163 | May, 1998 | Robinson |
| 5,770,970 | June, 1998 | Ikeda et al. |
| 5,802,452 | September, 1998 | Grandfield et al. |
| 5,809,398 | September, 1998 | Moberg et al. |
| 5,812,933 | September, 1998 | Niki. |
| 5,815,108 | September, 1998 | Terk. |
| 5,832,364 | November, 1998 | Gustafson. |
| 5,832,365 | November, 1998 | Chen et al. |
| 5,854,611 | December, 1998 | Gans et al. |
| 5,995,804 | November, 1999 | Rootsey et al. |

What is claimed is:

1. A 2-way pager, comprising:
a transceiver for transmitting a sent page and for receiving a received page;
a user interface for displaying information of the received page and for inputting information of the sent page;
memory configured to store a list of pagee IDs, a list of page codes and an emergency page list, the emergency page list defining one or more pagees;
an emergency page function for sending, using the transceiver, an emergency page to each pagee defined within the emergency page list; and
a processor responsive to the user interface and the memory for associating a selected pagee ID with a selected page code to compose the sent page, and for invoking the emergency page function.

2. The pager of claim 1, further comprising a network ID that is included in the sent page and sent emergency pages, the processor responsive to ignore a received page and a received emergency page that does not include a corresponding network ID.

3. The pager of claim 1, further including repeater functionality that comprises repeating each sent page and each page confirmation.

4. The pager of claim 1, further comprising an encoding algorithm for encoding sent pages and decoding received pages.

5. The pager of claim 1, further comprising a belt clip that attaches the pager to an item of clothing, the belt clip including a pivot to allow the pager to be rotated for viewing and operation while attached to the clothing.

6. The pager of claim 1, further comprising application software for implementing functionality specific to one particular use of the pager.

7. A method for duplicating configuration of a pager, comprising:
setting one or more second pagers into a clone receive mode;
setting a first pager to be cloned into a clone transmit mode;
wherein the first pager performs the steps of:
transmitting an ID of the first pager;
transmitting contact information from stored data of the first pager;
transmitting pager code information from the stored data;
wherein each of the second pagers has a second pager ID and performs the steps of:
receiving the first pager's ID;
receiving the contact information;
updating the contact information by replacing the second pager's ID with the first pager's ID;
storing the updated contact information within a memory of the second pager;
receiving the pager code information;
storing the pager code information within the memory of the second pager;
transitioning the first pager back to a normal operation mode; and
transitioning the second pager back to a normal operation mode.

8. The method of claim 7, further comprising:
transmitting an emergency page list from the memory of the first pager;
receiving the emergency page list at the second pager;
updating, at the second pager, the emergency page list by replacing the second pager's ID with the first pager's ID;
storing, within the memory of the second pager, the updated emergency page list.

9. The method of claim 7, further comprising clearing the stored data from the memory of the 2-way pager when set to clone receive mode.

10. A software product comprising instructions, stored on computer-readable media, wherein the instructions, when executed by a processor, perform steps for two-way paging between a first wireless device and a second wireless device, comprising:
instructions for accepting, at the first wireless device, input from a user of the first wireless device, the input composing information of a first page on the first wireless device, the input specifying the second wireless device as the recipient of the first page, the first page comprising information of a pager ID of the first wireless device, a pagee ID of the second wireless device, and a page code;
instructions for transmitting the first page from the first wireless device to the second wireless device;
instructions for receiving, at the second wireless device, the first page;
instructions for ignoring, at the second wireless device, the first page if the pagee ID is not equal to a pager ID of the second wireless device;
instructions for displaying the first page on a display of the second wireless device if the pagee ID is equal to a pager ID of the second wireless device; and
instructions for sending, from the second wireless device, a page confirmation message to the first wireless device to confirm that the first page was received.

11. The software product of claim 10, wherein the first wireless device comprises one of an Apple™ iPhone™ and an Apple™ iTouch™.

12. The software product of claim 10, further comprising instructions for placing buttons used for accepting key sequences on a touch-screen display of the first wireless device.

13. The software product of claim 12, further comprising:
instructions for accepting data input from an accelerometer;
instructions for processing data from the accelerometer; and
instructions for configuring the wireless device based on the processed data from the accelerometer.

14. The software product of claim 10, wherein the page further comprises a network ID.

15. The software product of claim 10, further comprising instructions for configuring the wireless device to repeat the second page received from the second wireless device.

16. The software produce of claim 10, further comprising instructions for operating the wireless device in a local wireless network with other wireless devices.

17. The software product of claim 16, further comprising instructions for operating the wireless device in the local wireless network operating with a wireless router.

18. The software product of claim 16, further comprising instructions for operating the wireless device in the local wireless network operating without a wireless router.

19. The software product of claim 10, the instructions for accepting further comprising instructions for accepting input from the user identifying at least one electronic file, the at least one electronic file being attached to the first page.

20. The software product of claim 19, the at least one electronic file containing one or more of: text, audio, video, and still images.
